(19) United States
(12) Patent Application Publication
(10) Pub. No.: US 2026/0081417 A1
(43) Pub. Date: Mar. 19, 2026

(54) Modular Facts Devices with External Fault Current Protection

(71) Applicant: Smart Wires Inc., Durham, NC (US)

(72) Inventors: Haroon Inam, San Jose, CA (US); Debrup Das, Union City, CA (US); Amrit Iyer, St. Petersburg, FL (US)

(21) Appl. No.: 19/396,022

(22) Filed: Nov. 20, 2025

Related U.S. Application Data
(63) Continuation of application No. 18/399,474, filed on Dec. 28, 2023, now Pat. No. 12,483,020.
Application No. 18/399,474 is a continuation of application No. 17/592,331, filed on Feb. 3, 2022, now Pat. No. 11,888,308.
Application No. 17/592,331 is a continuation of application No. 16/852,048, filed on Apr. 17, 2020, now Pat. No. 11,309,701.
Application No. 16/852,048 is a continuation of application No. 15/694,605, filed on Sep. 1, 2017, now Pat. No. 10,666,038.
(60) Provisional application No. 62/527,873, filed on Jun. 30, 2017.

(51) Int. Cl. H02H 3/16; H02H 7/16; H02H 7/26; H02H 9/04; H02H 9/06; H02J 3/06; H02J 3/18

(52) U.S. Cl. CPC H02H 3/162; H02H 7/16; H02H 9/041; H02J 3/06; H02J 3/18; H02J 3/1807; H02H 7/26; H02H 9/06

(57) ABSTRACT

Flexible AC transmission system (FACTS) enabling distributed controls is a requirement for power transmission and distribution, to improve line balancing and distribution efficiency. These FACTS devices are electronic circuits that vary in the type of services they provide. All FACTS devices have internal circuitry to handle fault currents. Most of these circuits are unique in design for each manufacturer, which make these FACTS devices non-modular, non-interchangeable, expensive and heavy. One of the most versatile FACTS device is the static synchronous series compensator (SSSC), which is used to inject impedance into the transmission lines to change the power flow characteristics. The addition of integrated fault current handling circuitry makes the SSSC and similar FACTS devices unwieldy, heavy, and not a viable solution for distributed control. What is disclosed are modifications to FACTS devices that move the fault current protection external to the FACTS device and make them modular and re-usable.

### CROSS-REFERENCE TO RELATED APPLICATIONS

This application is a continuation of U.S. patent application Ser. No. 18/399,474 filed on Dec. 28, 2023, which is a continuation of U.S. patent application Ser. No. 17/592,331 filed on Feb. 3, 2022, which is a continuation of U.S. patent application Ser. No. 16/852,048 filed Apr. 17, 2020, which is a continuation of U.S. patent application Ser. No. 15/694,605 filed Sep. 1, 2017, which claims the benefit of U.S. Provisional Patent Application No. 62/527,873 filed Jun. 30, 2017, the disclosures of which are incorporated herein by reference.

### BACKGROUND OF THE INVENTION

### 1. Field of the Invention

The present invention relates to systems and methods for flexible AC transmission systems (FACTS) and specifically to use of distributed power transmission and distribution control by static synchronous series compensators and other FACTs devices.

### 2. Prior Art

FACTS based distributed control of transmission lines and connected distributed generation capabilities and loads have become very critical for improving the efficiency of the power grid. In flexible AC transmission systems (FACTS), power flow control devices vary in the type of services they can provide. Devices operate in either series or shunt modes, and are highly complex and sophisticated pieces of machinery that require long planning cycles and preparation before installation.

Many of the FACTS devices use high voltage semiconductor-based power electronic converters to control the required parameters, such as line current, bus voltage, and more. Although converter-based FACTS devices provide more granular and faster control than electro-mechanical devices such as Phase Shifting Transformers, the former have significant limitations in fault-handling capability. The cost and complexity of the fault-handling strategy and circuit design in a FACTS device is one of the significant limitations and is considered one of the main deterrents for large-scale adoption of the FACTS technology.

Furthermore, most FACTS devices today are custom-built for specific applications, thus, no plug-and-play solution exists today. The lack of a solution is due to the unique design of the fault handling capability designed and implemented by individual suppliers of the FACTS systems and modules.

During a typical fault on the power grid very high currents appear on the transmission lines of the grid. These fault conditions can be short lived, such as those due to a lightning strike or they can be extended such as those due to ground shorts. Since the electronic components and thyristor used in todays'FACTS devices are prone to failure when such currents are impressed on them, these conditions must be handled by the fault protection circuitry. The high, short-duration faults are generally diverted away from sensitive semi-conductor switches (like IGBTs) using fast acting, more robust switches such as SCRs, electro-mechanical contactors, etc. In additions the circuits may also use metal oxide varistors (MOVs) to limit voltage rise. MOVs have a resistance value that reduces with the voltage applied across it.

FIG. 1 shows a prior art implementation 100 of a thyristor controlled Series compensator (TCSC) or a synchronous static series compensator (SSSC) 104 that includes the fault current protection as part of the power grid system 100. The power system comprises: the generator 101, the transformer 102, for stepping up the voltage for transmission over the transmission line 105. The circuit breaker (CB) 103 is used to isolate the generator 101 from the transmission line 105 and any FACTS devices like TCSC or SSSC 104 in case of ground short 108. A second breaker 106 is used to isolate the power grid from the load 107. During regular operation, the TCSC or the SSSC 104 provide the capability for the line to be efficiently used for transfer of power.

FIG. 2 is a prior art example of the series capacitive compensation for the inductance of the power lines. As can be seen the protection circuit associated with the capacitor 202 in series with the power line 201 comprise the MOV bank 203 and a triggered gap 205, which may be a vacuum bottle, in series with an inductance 204 used to limit the current through the vacuum bottle or in the case of longer time periods the bypass CB 206.

FIG. 3 is a prior art example of a single TCSC unit 307 with the associated fault current protection circuits. The TCSC 307 with the re-closer switch 306, and in combination with the inductor ‘L’ 305 in parallel with the capacitor ‘C’ 304 is able to inject both capacitive or inductive impedances on the power line 201 based on the firing of the thyristors, the control being provided by the firing angle and duration. The protection circuitry includes the MOV 203 stack, the triggered air/vacuum gap 205, and the bypass breaker 206. The triggered air gap 205 and the bypass breaker have the damping circuit 204 to reduce oscillations and provide a current limit. In addition to the fault current protection the FIG. 3 also shows the circuit breakers 303 A and 303 B which allow the TCSC module to be disconnected from the line 201 and a re-closer breaker 302 for reconnecting the TCSC when a fault is repaired.

These prior art FACTS based power flow control modules show the control circuits with the fault protection associated with it. The fault protection makes the control units large and unwieldy. It is hence only efficient to have the power flow control modules in substations and not usable effectively in distributed control applications.

It will be ideal if the fault handling capability can be removed from inside the FACTS systems and modules to an external protection scheme. The individual FACTS modules and systems then become modular and capable of plug and play. In addition the modular FACTS devices are lighter and smaller and can thus be useable in distributed applications on the grid.

### BRIEF DESCRIPTION OF THE DRAWINGS

The drawings are made to point out and distinguish the invention from the prior art. The objects, features and advantages of the invention are detailed in the description taken together with the drawings.

FIG. 1 is a prior art system block diagram 100 of thyristor controlled series compensator (TCSC) with breaker protections as part of the power grid system.

FIG. 2 is a prior art block diagram 200 of a series capacitor bank including the fault current protection components.

FIG. 3 is an exemplary prior art block diagram 300 showing the internal components including fault protection components of the TCSC of FIG. 1. (Prior Art)

FIG. 4 is an exemplary block diagram 400 of TCSC without fault current protection and its block representation 401 as per an embodiment of the current invention.

FIG. 5 is an exemplary block diagram 500 of an SSSC without fault current protection and its block representation 501 as per an embodiment of the current invention.

FIG. 6 is an exemplary block diagram 600 of an implementation of the fault current protection module and its single block representation 601 as per an embodiment of the present invention.

FIG. 7 is an exemplary power grid system block diagram 700 with TCSC 401 or SSSC 501 with external Fault current protection 601 and bypass and ground isolation protections.

FIG. 8 is an exemplary diagram showing multiple SSSCs 501s deployed in series being protected by an external fault current protection module 601, the SSSCs further being enabled for isolation and ground connection using breakers.

FIG. 9 is an exemplary deployment of two groups of TCSCs in series parallel configuration with external fault current protection.

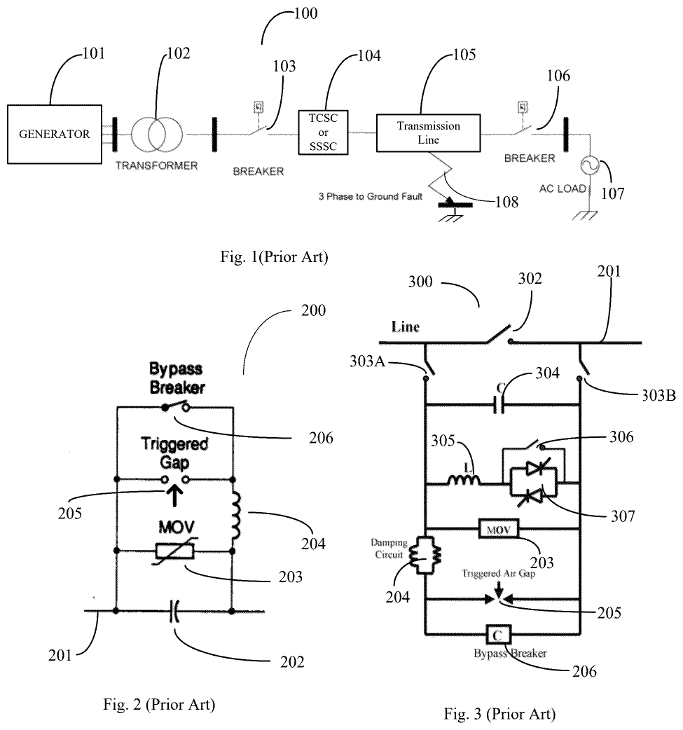

### DETAILED DESCRIPTION OF THE PREFERRED EMBODIMENTS

The primary change to the FACTS devices is moving the unit-level fault protection module external to the FACTS device. This provides:

Substantial reduction in volume and weight of the FACTS devices allowing them to be used in (1) distributed applications; (2) applications where a plurality of FACTS devices need to be configured and used as a group. In that regard, the reduction in volume allows heat generated within the FACTS devices to more readily pass out.

The system reliability is improved due to reduction in the number of modules/components used, that result in reducing the number of failure points or nodes within the implemented modules and sub-systems.

The removal of custom designed fault protection modules enables standardization of the FACTS modules for use in distributed applications requiring lower cost.

Flexible AC transmission system (FACTS) enabling distributed controls is a requirement for power transmission and distribution, to improve line balancing and distribution efficiency. These FACTS devices are electronic circuits that vary in the type of services they provide. All FACTS devices have internal circuitry to handle fault currents. Most of these circuits are unique in design for each manufacturer, which make these FACTS devices non-modular, non-interchangeable, expensive and heavy. One of the most versatile FACTS device, the static synchronous series compensator (SSSC) is used to inject impedance into the transmission lines to change the power flow characteristics. The addition of integrated fault current handling circuitry makes the SSSCs and similar FACTS devices unwieldy, heavier and not viable as a solution for distributed control. What is disclosed are modifications to FACTS devices that move the fault current protection external to the FACTS device and make them modular and re-usable.

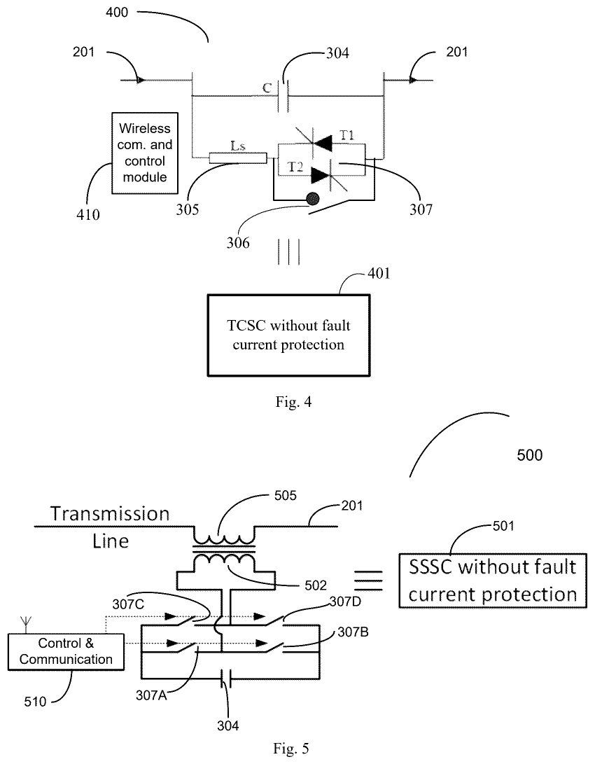

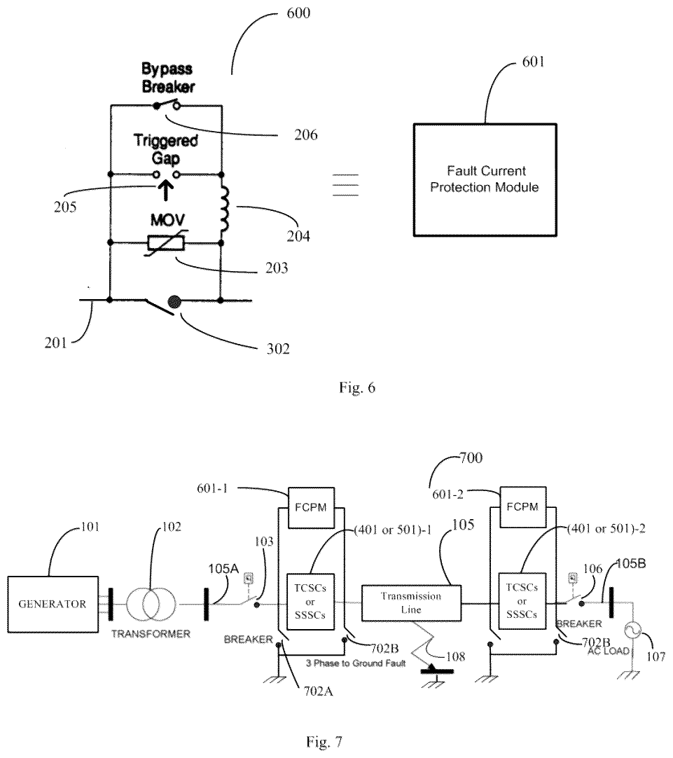

FIG. 4 shows a TCSC module 400 wherein the fault current protection circuit has been removed. The TCSC module 400 is connected in series with power line 201. Module 400 comprise two branches in parallel, one branch being the capacitor ‘C’ 304 and the second branch being the inductor ‘L’ 305 in series with the thyristor switching unit 307. A recloser switch 306 is connected in parallel with the thyristor switching unit 307 to shunt the unit when reclosure is necessary. By controlling the firing frequency and firing angle of the thyristors in the thyristor switching unit 307 the module is able to impress either an inductive or a capacitive impedance on the power line 201 to control the power flow on the line 201. The control instructions and coordination of the TCSC 400 in distributed situations mandate coordinated action with other TCSC modules 400 and any fault protection units external to the TCSC module 400. A dedicated communication module 410 communicably links the TCSC module 400 to other FACTS modules, external fault protection units and control and coordination facility. Similar communication modules are used with all TCSC modules, SSSC modules and FCPM modules (fault current protection modules such as illustrated in FIGS. 6-9, though not shown therein so as to not obscure the points being illustrated. A representative block of the TCSC module 400 is shown as block 401.

Similar to FIG. 4, FIG. 5 shows the SSSC module 500 with the fault protection circuitry removed. The SSSC 500 is shown as being coupled to the power line 201 by an injection transformer, having a primary winding 505 in series with the line 201 and a secondary winding 502. Similar to the TCSC module 400, the SSSC module 500 contain the HV switches 301A to 307D connected across the secondary 502 of the injection transformer as well as a capacitor C 304 in parallel as shown. A dedicated communication module 510 allow the SSSC module 500 to coordinate with other FACTS control devices, external fault protection units and control and coordination facility in a manner similar to the TCSC module 400. The SSSC 500 module is represented as a block by the equivalent block 501.

FIG. 6 shows an exemplary external fault current protection module (FCPM) 600. The FCPM 600 is connected to the line 201 spanning the circuits to be protected. It comprise the MOV 203 to handle the short duration faults, surges and transients, a triggered gap 205 in series with a current limiting inductor 204 to handle longer faults, and a bypass switch 206 to handle short circuits and ground short conditions. It also has a recloser switch 302 to enable the system to be reset when the faults are removed. The exemplary external FCPM 600 is also represented by the FCPM block 601. An FCPM 601 may be hung from a transmission line or supported by a separate support, such as a separate ground based or tower support, or as a further alternative, the FCPM as well as the TCSCs and/or SSSCs may be located in a substation, such as by way of example, a substation provided specifically for that purpose.

As discussed previously, each manufacturer of the prior art FACTS device custom designed the FCPM to suit their design requirements and manufacturing capabilities. By removing the non-standardized fault current protection devices from the prior art TCSC 300 and the prior art SSSC, new modular and standardized TCSC 401 and SSSC 501 that handle the desired function are made available from all FACTS manufacturers. These standardized TCSC 401 and SSSC 501 are much smaller in size, lower in weight, and usable in a distributed fashion. Having the external FCPM 601 separate from the modular TCSC 401 and SSSC 501 makes arranging a plurality of these standardized FACTS modules in parallel or in series with a single external FCPM 601 module to handle power transfer requirements of the power grid, reducing the cost and efficiency of such implementation.

One of the challenges that arise when a plurality of the FACTS modules are connected in parallel or in series, as a group, is the need for coordinating their operation to achieve the operational goals. High speed and secure inter module, group to group and group to facility control is essential for the proper operation of the inter linked FACTS devices and the single connected fault current protection module. Secure and dedicated communication techniques including line of sight wireless communication using 60 and 80 Ghz bands, direct communication using lasers etc. The challenge also extends to the operational integration requirement for control between the plurality of FACTS devices connected. This includes decision on which of the connected devices should be active at any point in time and when the various protection devices should become active.

FIG. 7 shows an exemplary block diagram 700 of implementation of the external FCPM 601 with FACTS modules like TCSC 401 or SSSC 501 modules on a power grid. The block diagram 700 is similar to the FIG. 1 block diagram 100 and shows two sets of modular FACTS units such as TCSC 401 and SSSC 501 used instead of a single unit having the fault protection built in. Each of the modular plurality of FACTS units are protected by one FCPM 601-1.

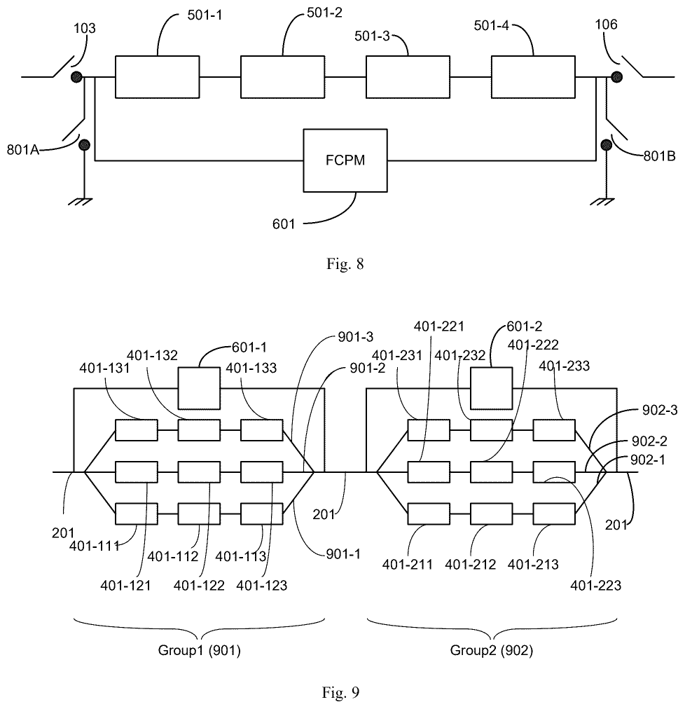

FIG. 8 shows a block diagram 800 of one arrangement of the FACTS units such as SSSC 501-1 to 501-4 in a series connection with one external FCPM 601. Two circuit breakers 103 and 106 are shown for isolating the modular FACTS units and the faulty line section between a first bus 105A and a second bus 105B from the rest of the transmission system, in case of failure 108. Two additional ground connected breakers 801A and 801B are also provided to allow discharging of the set of FACTS modules and the section of the isolated transmission line when disconnected from the transmission system using breakers 103 and 106.

FIG. 9 shows a block diagram 900 showing an alternate way for arranging the plurality of FACTS devices such as TCSC 401 in a parallel serial connection. Each of the two groups of nine TCSC 401 devices 901 and 902 shown as example are connected in strings of three devices and arranged in three parallel interconnected strings. The devices are designated as 401-gsp; where g is the group, s is the string and p is the position of the device on the string. Hence a TCSC 401 in group 2, on the second string at second position will be 401-222 and a TCSC 401 of the 1st group in the 3rd string first position will have a designation 401-131 and so on. Each group of nine TCSC 401s are shown as being protected by a single external FCPM 601.

The organization of the groups with the capability to isolate the protected groups provide a big advantage to the serviceability of the grid system. It is hence possible if a failure occurs in the FCPM 601 module or any of the individual FACTS 401 modules, to isolate the failed module and replace the same with a similar module that is standardized and pre-tested. The selective enablement of groups of FACTS 401 devices for power flow control and serviceability without disrupting normal operations is hence fully enabled by the modular replacement capability and standardization of the FACTS 401 and FCPM 601 modules used.

The removal of the fault current protection module, by design, from each FACTS device has numerous advantages. It reduces cost by eliminating unnecessary duplication of heavy circuitry, itself very advantageous when the FACTS devices are to be hung from the transmission line. It reduces the volume (wind forces) and the cooling requirements of each FACTS device. It also allows and encourages standardization of the FACTS modules in performance and control, and similarly allows independent selection of a fault current protection module design for broad use, again standardizing their performance, communication and control requirements. Using a fault current protection module having a recloser switch such as switch 302 (FIG. 6), a protected group of FACTS devices can be functionally isolated from the respective transmission line by closing the recloser switch to remove or divert transmission line current around that group of FACTS devices, which may be useful in normal operation, and particularly useful upon a failure or excess heating of a respective FACTS device in that group.

Even though the invention disclosed is described using specific implementation, it is intended only to be exemplary and non-limiting. The practitioners of the art will be able to understand and modify the same based on new innovations and concepts, as they are made available. The invention is intended to encompass these modifications.

Thus, the present invention has a number of aspects, which aspects may be practiced alone or in various combinations or sub-combinations, as desired. Also while certain preferred embodiments of the present invention have been disclosed and described herein for purposes of exemplary illustration and not for purposes of limitation, it will be understood by those skilled in the art that various changes in form and detail may be made therein without departing from the spirit and scope of the invention.

What is claimed is:

1. A fault current protection device for a power grid system, the fault current protection device comprising:
a bypass breaker configured to isolate a plurality of flexible alternating current transmission systems (FACTS) devices from a power transmission line, to protect the plurality of FACTS devices from a fault current on the power transmission line; and
a recloser switch configured to reset the power grid system when the fault current is removed;
wherein the fault current protection device is connectable to the power transmission line, separate from the plurality of FACTS devices, and in parallel with the plurality of FACTS devices.

2. The fault current protection device of claim 1, further comprising a metal oxide varistor (MOV) in parallel with the bypass breaker and the recloser switch.

3. The fault current protection device of claim 1, further comprising a triggered gap in parallel with the bypass breaker and the recloser switch.

4. The fault current protection device of claim 3, further comprising an inductor in series with the triggered gap.

5. The fault current protection device of claim 1, wherein the fault current protection device is in communication with the plurality of FACTS devices via a communication module that enables the plurality of FACTS devices to coordinate with the fault current protection device.

6. The fault current protection device of claim 1, wherein the bypass breaker is configured to isolate the plurality of FACTS devices from the power transmission line comprises the bypass breaker is configured to remove or divert transmission line current from the plurality of FACTS devices.

7. The fault current protection device of claim 1, wherein the plurality of FACTS devices are connected in series.

8. The fault current protection device of claim 1, wherein the plurality of FACTS devices are connected in parallel.

9. The fault current protection device of claim 1, wherein the plurality of FACTS devices comprises a first set of FACTS devices connected in series and a second set of FACTS devices connected in parallel.

10. The fault current protection device of claim 1, wherein the plurality of FACTS devices comprises static synchronous series compensators (SSSCs) or thyristor controlled series compensators (TCSCs).

11. A system for fault current protection in a power grid system, the system comprising:
a plurality of fault current protection devices, each fault current protection device comprising:
a bypass breaker configured to isolate a plurality of flexible alternating current transmission systems (FACTS) devices from a power transmission line, to protect the plurality of FACTS devices from a fault current on the power transmission line; and
a recloser switch configured to reset the power grid system when the fault current is removed;
wherein the fault current protection device is connectable to the power transmission line, separate from the plurality of FACTS devices, and in parallel with the plurality of FACTS devices.

12. The system of claim 11, wherein each fault current protection device further comprises a metal oxide varistor (MOV) in parallel with the bypass breaker of the fault current protection device and the recloser switch of the fault current protection device.

13. The system of claim 11, wherein each fault current protection device further comprises a triggered gap in parallel with the bypass breaker of the fault current protection device and the recloser switch of the fault current protection device.

14. The system of claim 13, wherein each fault current protection device further comprises an inductor in series with the triggered gap of the fault current protection device.

15. The system of claim 11, wherein the fault current protection device is in communication with the plurality of FACTS devices via a communication module that enables the plurality of FACTS devices to coordinate with the fault current protection device.

16. The system of claim 11, wherein the bypass breaker is configured to isolate the plurality of FACTS devices from the power transmission line comprises the bypass breaker is configured to remove or divert transmission line current from the plurality of FACTS devices.

17. The system of claim 11, wherein the plurality of FACTS devices are connected in series.

18. The system of claim 11, wherein the plurality of FACTS devices are connected in parallel.

19. The system of claim 11, wherein the plurality of FACTS devices comprises a first set of FACTS devices connected in series and a second set of FACTS devices connected in parallel.

20. The system of claim 11, wherein the plurality of FACTS devices comprises static synchronous series compensators (SSSCs) or thyristor controlled series compensators (TCSCs).
